(19) United States
(12) Patent Application Publication
(10) Pub. No.: US 2025/0129858 A1
(43) Pub. Date: Apr. 24, 2025

(54) VALVE CORE AND SENSOR FAUCET

(71) Applicants: Xiliang YAN, Fujian (CN); Mouyong LIN, Fujian (CN)

(72) Inventors: Xiliang YAN, Fujian (CN); Mouyong LIN, Fujian (CN)

(21) Appl. No.: 18/898,716

(22) Filed: Sep. 27, 2024

(30) Foreign Application Priority Data
Oct. 18, 2023 (CN) 202311348832.8

(51) Int. Cl. F16K 11/074

(52) U.S. Cl. CPC F16K 11/0743

(57) ABSTRACT

A valve core having a housing, a stationary disc, a movable disc, and a valve stem; the stationary disc and the movable disc are installed in the housing; there are two inlet holes and two outlet holes on the stationary disc; the two outlet holes are two arc-shaped holes at upper and lower portions of the stationary disc, and the two inlet holes are provided at left and right portions of the stationary disc and within an area of circular enclosure defined by the two outlet holes; the movable disc is movably and sealingly engaged with the stationary disc; the movable disc has a water passage groove; the valve stem is inserted into the housing to drive the movable piece to slide and/or rotate on the stationary disc.

### BACKGROUND OF THE INVENTION

The present invention relates to the technical field of faucet valve cores, and in particular, to a valve core and a sensor faucet.

Sensor faucets utilize the principle of infrared reflection. When a hand is placed in the infrared region, the hand can be detected, thereby sending a signal to the solenoid valve to control the water output from the faucet. Once the hand leaves the infrared region, the solenoid valve controls the faucet to turn off.

In the state of art, there are products that integrate mechanical control and solenoid valve control within a sensor faucet, meaning that the sensor faucet can not only achieve the expected sensor water output function but can also be manually controlled to turn on and off using handles or other switch devices. To avoid interference between the mechanical control and solenoid valve control functions, the currently available sensor faucets are designed with two water output paths within the valve core. The opening and closing of the two water output paths are controlled by the valve core itself and the solenoid valve respectively. This design ensures that the sensor water output function will not be affected when users use the handle to control the faucet, and users do not need to operate the handle when using the sensor water output function, thus enhancing user's experience.

However, the aforementioned products are defective in that the water output path corresponding to the solenoid valve is only controlled to be opened or closed by the solenoid valve. If the solenoid valve is damaged during use and cannot properly close the water path, water leakage can be resulted. The only way to prevent water leakage is to block or cut off the inlet end of the valve core, which also disables the water output function through the mechanical control. A solution to this problem provided in the state of art is to provide a dedicated on-off control device between the solenoid valve's input end and the valve core. The on-off control device is always activated, and can be manually deactivated when necessary. The above-mentioned solution increases the equipment costs and requires the faucet body to be specially designed with a new mold to provide space for installing the on-off control device, which is a rather troublesome and complicated solution. Prior art CN215445174U discloses a “DUAL-IN DUAL-OUT VALVE CORE”, where a first mixed water outlet (solenoid valve water outlet) always communicates with a first water outlet channel and cannot be closed. Additionally, a second mixed water channel is formed between an upper part of a movable valve disc and a dial, which introduces additional sealing that increases the risk of water leakage. Prior art CN214838579U discloses a “DUAL-IN DUAL-OUT INTEGRATED MIXED WATER VALVE CORE”, which requires toggling a handle up and down to achieves two different water outlets respectively, thus increasing the user's cost of use due to additional learning of how to use the product. Moreover, a second mixed water channel is formed between an upper part of a movable valve disc and a dial, which introduces additional sealing that increases the risk of water leakage. Furthermore, the mechanical water outlet (first mixed water channel) has a small water passage flow area and small amount of water flow. Prior art CN211738164U discloses a “VALVE CORE WITH DUAL INLETS AND DUAL OUTLETS FOR SENSOR WATER OUTPUT”, where a first mixed water outlet (solenoid valve water outlet) always communicates with a first water outlet channel and cannot be closed. Prior art CN212672445U discloses a “VALVE CORE”, which is difficult to adjust to a third water outlet mode because the first outlet hole does not communicate with any inlet hole, and the second outlet hole does not communicate with any inlet hole. Additionally, a second mixed water channel is formed between an upper part of a movable valve disc and a dial, which introduces additional sealing that increases the risk of water leakage. Prior art CN210531654U discloses a “DUAL-IN DUAL-OUT HOT AND COLD WATER MIXED VALVE CORE”, where a first mixed water outlet (solenoid valve water outlet) always communicates with a first outlet channel and cannot be closed. Prior art CN211901679U discloses a “DUAL WATER PATH VALVE CORE”, where a movable valve disc has two independent water guide grooves; a thick middle wall between the two water guide grooves reduces the area of the hot and cold water inlets, resulting in small amount of water flow. To increase the amount of water flow, the valve core's shape and volume need to be appropriately enlarged, making it difficult to be used in scenarios where size limits apply.

### BRIEF SUMMARY OF THE INVENTION

In view of the aforesaid disadvantages in the prior art, it is an object of the present invention to provide a valve core and a sensor faucet. The optimized design of the valve core enables the valve core itself to have the function of controlling on and off of the sensor water output path, and allowing manual cutoff of the water path that communicates with the solenoid valve when needed.

To attain the above object, the present invention provides the following technical solutions:

A valve core, comprising a housing, a stationary disc, a movable disc, and a valve stem; the stationary disc and the movable disc are both installed inside the housing; the stationary disc is provided with a first outlet hole, a second outlet hole, a first inlet hole, and a second inlet hole; the first outlet hole and the second outlet hole are arc-shaped holes penetrating upper and lower portions of opposite sides of the stationary disc respectively; the first inlet hole and the second inlet hole penetrates left and right portions of the opposite sides the stationary disc, and the first inlet hole and the second inlet hole are disposed within an area of circular enclosure defined by the first outlet hole and the second outlet hole; the movable disc is movably and sealingly engaged with the stationary disc, and a surface of the movable disc adjacent to the stationary disc when the movable disc is engaged with the stationary disc is provided with a water passage groove; the valve stem is inserted into the housing and is connected to the movable disc to transmit motion so as to drive the movable disc to rotate and/or slide on the stationary disc; a length of the water passage groove ensures that when the movable disc moves on the stationary disc, the water passage groove is not in communication with any of the first outlet hole or the second outlet hole, or is in communication with either the first outlet hole or the second outlet hole at a respective end thereof; a length of the second outlet hole ensures that when the water passage groove is not in communication with the first outlet hole, the movable disc is capable to be rotated to an angle where the water passage groove is also not in communication with the second outlet hole.

A center of the circular enclosure defined by the first outlet hole and the second outlet hole coincides with a center of the stationary disc; and arc radii of both the first outlet hole and the second outlet hole are equal; a lengthwise direction of the water passage groove is oriented radially on the movable disc.

Preferably, a right end portion of an opening of the first outlet hole facing towards the movable disc and a right end portion of an opening of the second outlet hole facing towards the movable disc are shaped as up-side down mirror images; a left end portion of an opening of the second outlet hole facing towards the movable disc is shorter than a left end portion of an opening of the first outlet hole facing towards the movable disc.

Preferably, two sides of the water passage groove along a lengthwise direction thereof are shaped as arc-shaped sides; a space between the two arc-shaped sides gradually increases from a middle section to two end portions respectively.

Preferably, one side of an end portion of the water passage groove capable of being in communication with the second outlet hole is provided with a first cut-away portion that is capable of avoiding said end portion of the water passage groove from communicating with the second outlet hole; a corresponding end of the second outlet hole is provided with a second cut-away portion; when the water passage groove is not in communication with the first outlet hole and the movable disc is also being rotated to an angle where the water passage groove does not in communication with the second outlet hole as well, a gap exists between the first cut-away portion and the second cut-away portion to discontinue communication between the water passage groove and the second outlet hole.

The first outlet hole is configured to communicate with a mechanical water outlet end of a sensor faucet; the second outlet hole is configured to communicate with a sensor water outlet end of the sensor faucet; the first inlet hole is configured to communicate with a hot water inlet end; the second inlet hole is configured to communicate with a cold water inlet end.

Preferably, the valve core further comprises a dial and a mounting sleeve installed inside the housing; the dial is coaxially connected to the movable disc at a side of the movable disc that faces away from the stationary disc; the mounting sleeve is rotatably inserted into the housing; sliding grooves and flanges are provided on opposing surfaces of the mounting sleeve and the dial respectively; the flanges are slidably fitted within the sliding grooves; a through hole is provided penetrating two ends of the mounting sleeve; the valve stem passes through the through hole; a middle section of the valve stem is rotatably fitted to sidewalls of the through hole via a rotating shaft, and an end of the valve stem is embedded into the dial; when toggling the valve stem, the valve stem slides the dial relative to the mounting sleeve; when rotating the valve stem, the valve stem drives the mounting sleeve and the dial to rotate synchronously.

Preferably, a cross-section of the through hole has a rectangular shape; the sliding grooves are provided radially on the mounting sleeve.

Preferably, a surface of the dial which the end of the valve stem is embedded is provided with a slot so that the end of the valve stem is inserted into.

Preferably, the housing comprises an upper housing and a lower cover connected to each other along a vertical direction; the movable disc and the stationary disc are sequentially installed into the upper housing and being axially limited by the lower cover; the valve stem is inserted into the upper housing; a first sealing gasket is provided between the lower cover and the stationary disc.

Preferably, the lower cover is provided with a first water passage hole, a second water passage hole, a third water passage hole, and a fourth water passage hole; openings of the first water passage hole, the second water passage hole, the third water passage hole, and the fourth water passage hole on an upper surface of the lower cover are different from openings of the first water passage hole, the second water passage hole, the third water passage hole, and the fourth water passage hole on a lower surface of the lower cover; the openings of the first water passage hole, the second water passage hole, the third water passage hole, and the fourth water passage hole on the lower surface of the lower cover facing away from the stationary disc are of a same shape and size and are disposed evenly around an axis of the lower cover; openings of the first outlet hole, the second outlet hole, the first inlet hole, and the second inlet hole on an upper surface of the stationary disc are different from openings of the first outlet hole, the second outlet hole, the first inlet hole, and the second inlet hole on a lower surface of the stationary disc; the openings of the first water passage hole, the second water passage hole, the third water passage hole, and the fourth water passage hole on the upper surface of the lower cover facing towards the stationary disc correspond to the openings of the first outlet hole, the second outlet hole, the first inlet hole, and the second inlet hole on the lower surface of the stationary disc in terms of shape and size.

Preferably, the openings of the first inlet hole and the second inlet hole on the lower surface of the stationary disc facing towards the lower cover are in a same shape and size and are symmetrically provided as semicircular holes respectively; a first guiding slope is provided between an inlet end and an outlet end of the first inlet hole, and a second guiding slope is provided between an inlet end and an outlet end of the second inlet hole.

Preferably, the openings of the first outlet hole and the second outlet hole on the lower surface of the stationary disc facing towards the lower cover are of a same shape and size and are symmetrically provided as arc-shaped holes.

Preferably, opposing surfaces of the lower cover and stationary disc are provided with a first embedding groove and a second embedding groove respectively to correspond to the first sealing gasket; two sides of the first sealing gasket are embedded in the first embedding groove and the second embedding groove respectively, and the first sealing gasket is deformed by compressive force of the lower cover and the stationary disc.

Preferably, a periphery of the lower cover is provided with a plurality of buckles; a periphery of the stationary disc is provided with a plurality of recesses that correspond to the buckles; a periphery of the upper housing is provided with buckle holes that correspond to the buckles; the buckles are removably fitted into the recesses and buckle to the buckle holes.

The present invention further discloses a sensor faucet installed with the aforementioned valve core.

According to the technical solutions described above, the present invention has the following technical effects:
1. The present invention optimizes the design of the valve core by correspondingly designing the shapes and sizes of the inlet and outlet holes of the stationary disc and the water passage groove of the movable disc. This ensures that the water passage groove, when being operated to be in communication with any one of the outlet holes, can only be in communication with either the first outlet hole or the second outlet hole but not both at the same time, but the water passage groove can be in communication with either the first inlet hole or the second inlet hole, or both simultaneously. This design allows the valve core to have two mutually non-interfering water paths, making it applicable to application scenarios involving dual-function sensor faucets with mechanical control and sensor control as described in the background section.
2. When the water passage groove is not in communication with the first outlet hole, there is still a specific angle where the movable disc can be rotated to such that the water passage groove is also not in communication with the second outlet hole, thereby enabling the valve core to have a fully closed non-water output function that can be used to control on and off of the sensor water output path of the sensor faucet. This allows manual cutoff of the water path that communicates with the solenoid valve when needed, while still enabling normal operation of the mechanical water output path when mechanical control of water output is required.

### BRIEF DESCRIPTION OF THE DRAWINGS

FIG. 1 is a perspective view of a specific embodiment according to the present invention;

FIG. 2 is an exploded view of a specific embodiment according to the present invention;

FIG. 3 is a sectional view of a specific embodiment according to the present invention;

FIG. 4 is a top view of a stationary disc of a specific embodiment according to the present invention;

FIG. 5 is a bottom view of a movable disc of a specific embodiment according to the present invention;

FIG. 6 is a schematic view illustrating the state of full hot water output from a second outlet hole in a specific embodiment according to the present invention;

FIG. 7 is a schematic view illustrating the state of mixed hot and cold water output from the second outlet hole in a specific embodiment according to the present invention;

FIG. 8 is a schematic view illustrating the state of the second outlet hole being closed in a specific embodiment according to the present invention;

FIG. 9 is a schematic view illustrating the state of full hot water output from a first outlet hole in a specific embodiment according to the present invention;

FIG. 10 is a schematic view illustrating the state of mixed hot and cold water output from the first outlet hole in a specific embodiment according to the present invention;

FIG. 11 is a schematic view illustrating the state of full cold water output from the first outlet hole in a specific embodiment according to the present invention;

FIG. 12 is a first perspective view of the stationary disc of a specific embodiment according to the present invention;

FIG. 13 is a second perspective view of the stationary disc of a specific embodiment according to the present invention;

FIG. 14 is a sectional view of the stationary disc of a specific embodiment according to the present invention;

FIG. 15 is a first perspective view of a lower cover of a specific embodiment according to the present invention;

FIG. 16 is a second perspective view of the lower cover of a specific embodiment according to the present invention; and

FIG. 17 is a perspective view of a sensor faucet.

### DETAILED DESCRIPTION OF THE INVENTION

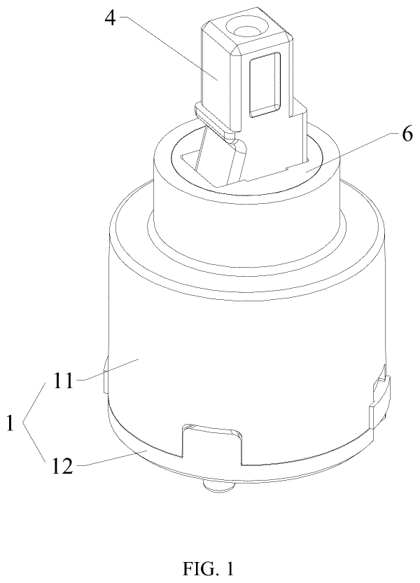

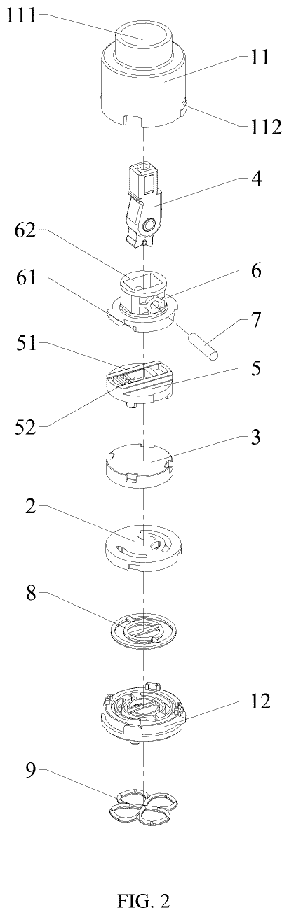

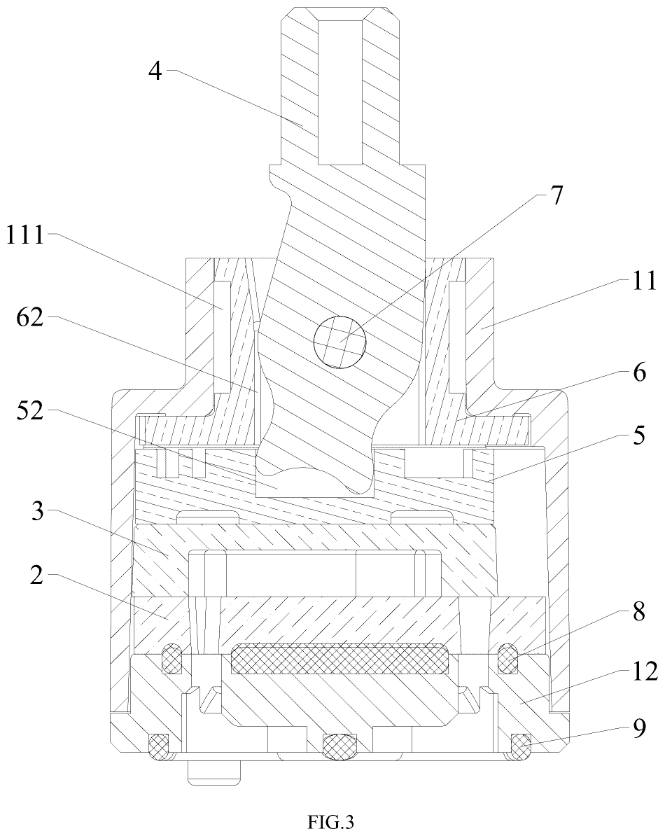

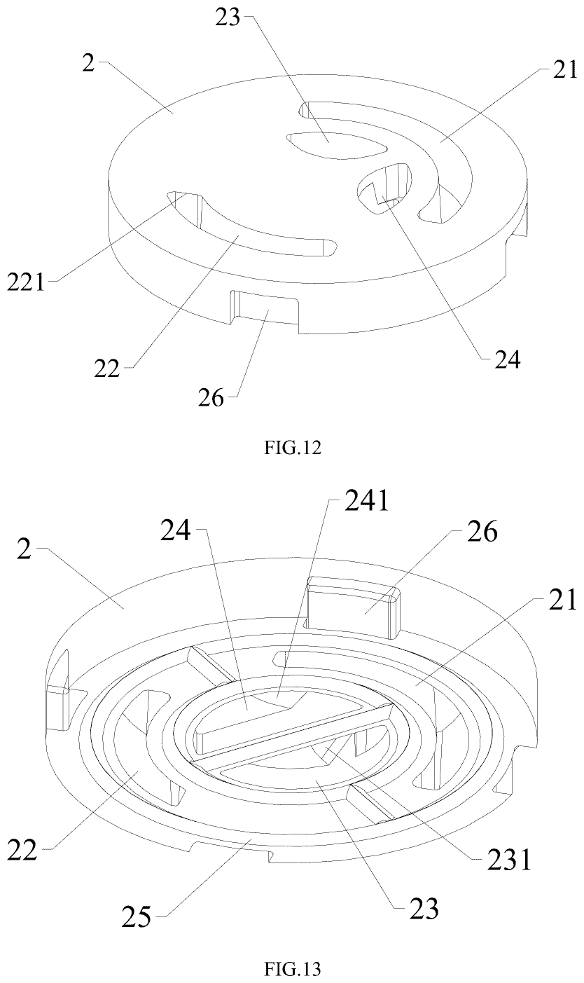

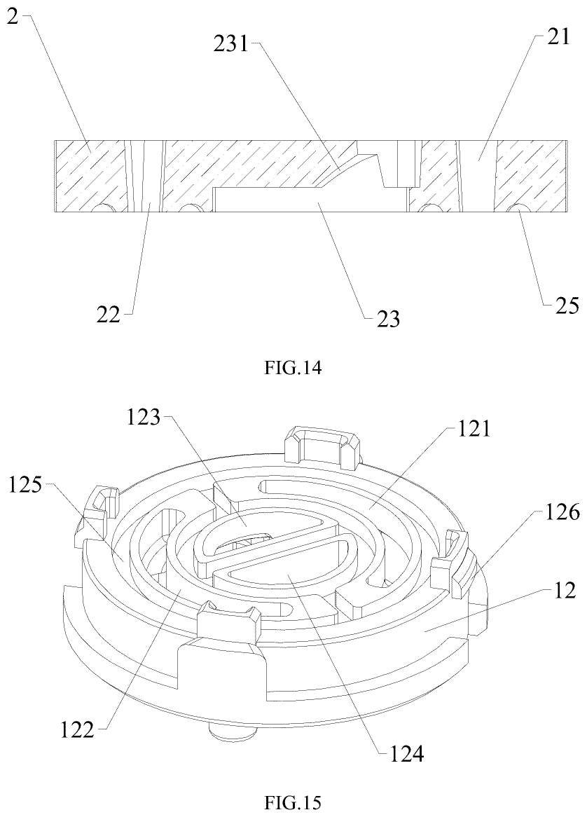

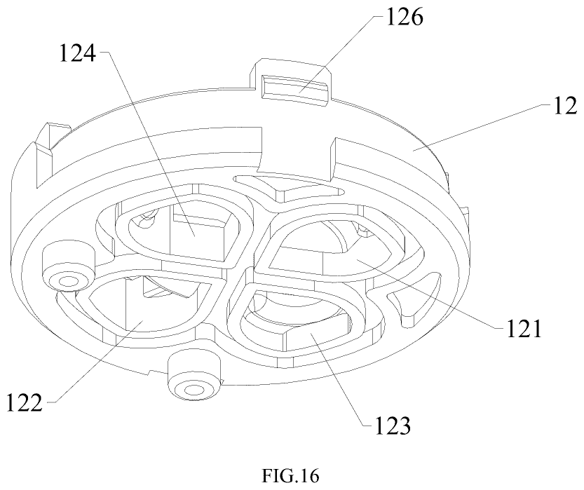

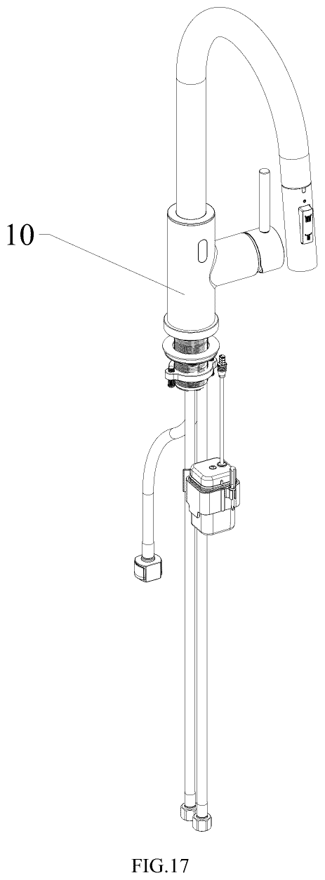

Referring to FIGS. 1 to 16, the present invention discloses a valve core, comprising a housing 1, a stationary disc 2, a movable disc 3, and a valve stem 4.

The stationary disc 2 and the movable disc 3 are both installed inside the housing 1.

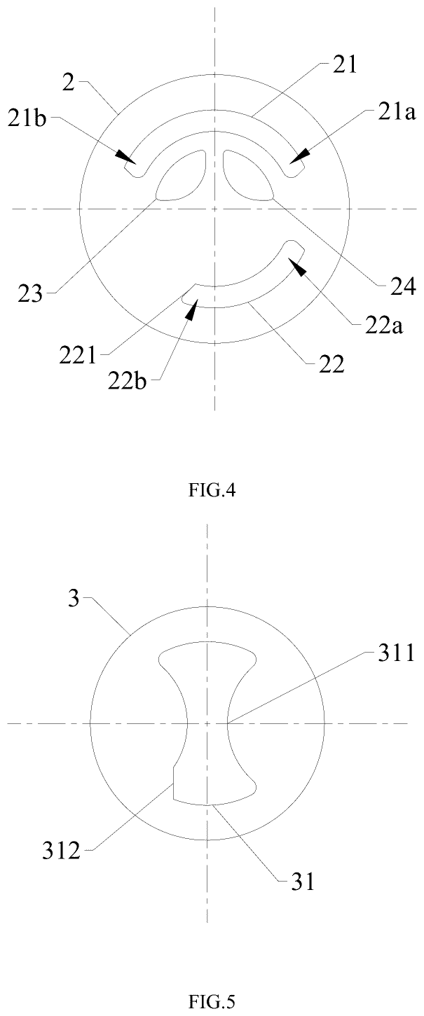

The stationary disc 2 is provided with a first outlet hole 21, a second outlet hole 22, a first inlet hole 23, and a second inlet hole 24; the first outlet hole 21 and the second outlet hole 22 are arc-shaped holes penetrating upper and lower portions of opposite sides of the stationary disc 2 respectively; the first inlet hole 23 and the second inlet hole 24 penetrates left and right portions of the opposite sides the stationary disc 2 (see FIG. 4), and the first inlet hole 23 and the second inlet hole 24 are disposed within an area of circular enclosure defined by the first outlet hole 21 and the second outlet hole 22.

The movable disc 3 is movably and sealingly engaged with the stationary disc 2, and a surface of the movable disc 3 that is adjacent to the stationary disc 2 when the movable disc 3 is engaged with the stationary disc 2 is provided with a water passage groove 31.

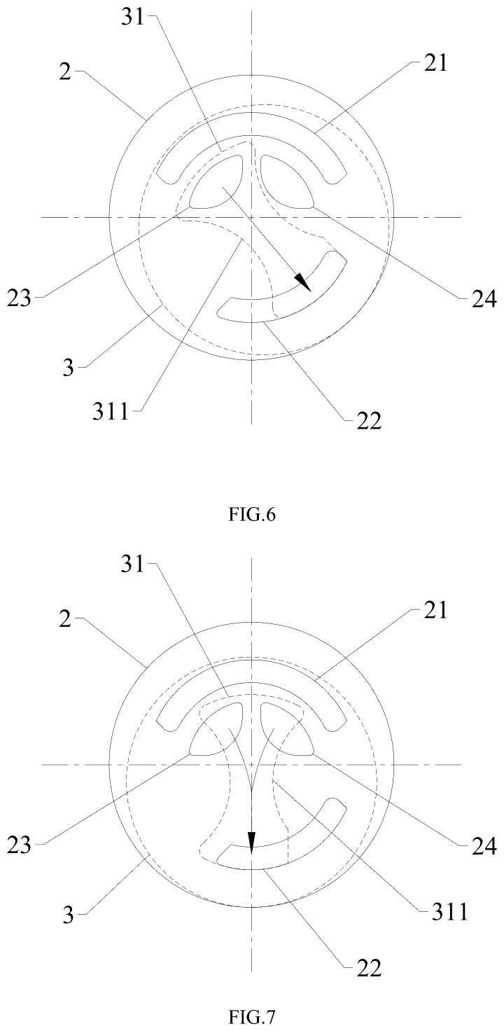

The valve stem 4 is inserted into the housing 1 and is connected to the movable disc 3 for motion transmission so as to drive the movable disc 3 to rotate and/or slide on the stationary disc 2 (see FIGS. 6 to 11).

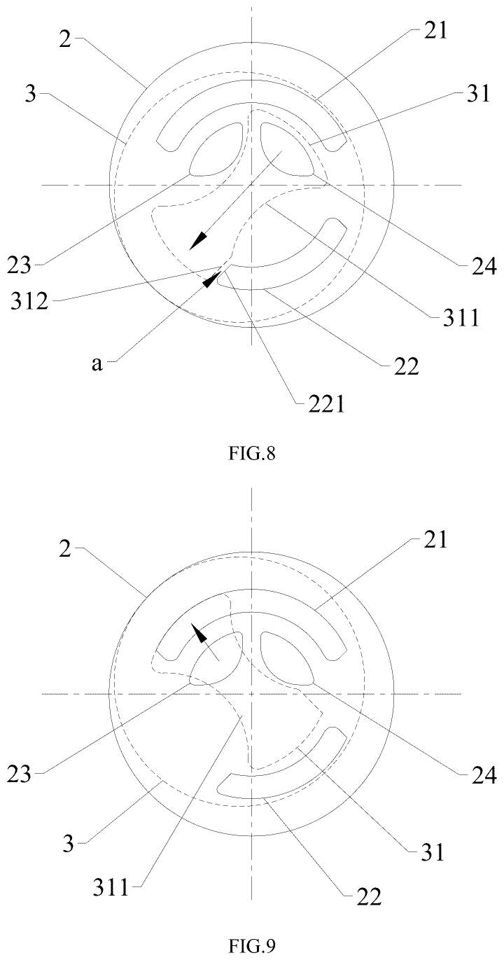

A length of the water passage groove 31 ensures that when the movable disc 3 moves on the stationary disc 2, the water passage groove 31 is not in communication with any of the first outlet hole 21 or the second outlet hole 22 (see FIG. 8), or is in communication with either the first outlet hole 21 or the second outlet hole 22 at a respective end thereof (see FIGS. 6-7, 9-11); a length of the second outlet hole 22 ensures that when the water passage groove 31 is not in communication with the first outlet hole 21, the movable disc 3 can be rotated to an angle where the water passage groove 31 is also not in communication with the second outlet hole 22 (see FIG. 8).

According to the above solution, the present invention optimizes the design of the valve core by correspondingly designing the shapes and sizes of the inlet and outlet holes of the stationary disc 2 and the water passage groove 31 of the movable disc 3. This ensures that the water passage groove 31, when being operated to be in communication with any one of the outlet holes, can only be in communication with either the first outlet hole 21 or the second outlet hole 22 but not both at the same time, but the water passage groove 31 can be in communication with either the first inlet hole 23 or the second inlet hole 24, or both simultaneously. This design allows the valve core to have two mutually non-interfering water paths, making it applicable to application scenarios involving dual-function sensor faucets with mechanical control and sensor control as described in the background section. When the water passage groove 31 is not in communication with the first outlet hole 21, there is still a specific angle where the movable disc 3 can be rotated to such that the water passage groove 31 is also not in communication with the second outlet hole 22, thereby enabling the valve core to have a fully closed non-water output function that can be used to control on and off of the sensor water output path of the sensor faucet. This allows manual cutoff of the water path that communicates with the solenoid valve when needed, while still enabling normal operation of the mechanical water output path when mechanical control of water output is required.

The following illustrates the specific embodiments of the present invention.

The first outlet hole 21, the second outlet hole 22, the first inlet hole 23, and the second inlet hole 24 are all provided to penetrate vertically between an upper surface and a lower surface of the stationary disc 2; the water passage groove 31 is recessed from a lower surface of the movable disc 3.

A center of the circular enclosure defined by the first outlet hole 21 and the second outlet hole 22 coincide with a center of the stationary disc 2; and arc radii of both the first outlet hole 21 and the second outlet hole 22 are equal, meaning that the first outlet hole 21 and the second outlet hole 22 are disposed on a same circle; a lengthwise direction of the water passage groove 31 is oriented radially on the movable disc 3. The above structures make the stationary disc 2 and the movable disc 3 more structurally regular, thereby facilitating adjustment of the amount of water flow between the stationary disc 2 and the movable disc 3 as well as a mixing ratio of hot and cold water. In this embodiment, a right end portion 21a of an opening of the first outlet hole 21 facing towards the movable disc 3 (i.e. the opening on an upper surface of the stationary disc 2) and a right end portion 22a of an opening of the second outlet hole 22 facing towards the movable disc 3 are shaped as up-side down mirror images; a left end portion 22b of an opening of the second outlet hole 22 facing towards the movable disc 3 is shorter than a left end portion 21b of an opening of the first outlet hole 21 facing towards the movable disc 3, such that when the movable disc 3 is being rotated such that the water passage groove 31 is located at a position corresponding to a position on the stationary disc 2 further leftward to a left end of the second outlet hole 22, the water passage groove 31 is not in communication with the second outlet hole 22 (see FIG. 8).

Furthermore, two sides of the water passage groove 31 along the lengthwise direction thereof are shaped as arc-shaped sides 311; a space between the two arc-shaped sides 311 (i.e. width of the water passage groove 31) gradually increases from a middle section to two end portions respectively, such that the water passage groove 31 form an elongated groove with a particular small waist portion. Designing the water passage groove 31 as such can increase the cross-sectional area at the two end portions of the water passage groove 31, thereby increasing the area of the water passage groove 31 that can be in communication with the first outlet hole 21/second outlet hole 22. Also, due to the arc-shaped sides 311, it is possible for the water passage groove 31 to avoid communication with one of the first inlet hole 23 and the second inlet hole 24 when it is in communication with another one of the first inlet hole 23 and the second inlet hole 24 (see FIGS. 6, 8, 9, and 11). Therefore, the cross-sectional areas of the first inlet hole 23 and the second inlet hole 24 can also be designed larger, which can increase the maximum amount of water inlet flow and maximum amount of water outlet flow of the valve core without changing the size of the valve core.

Secondly, one side of an end portion of the water passage groove 31 capable of being in communication with the second outlet hole 22 is provided with a first cut-away portion 312 that can avoid said end portion of the water passage groove from communicating with the second outlet hole 22; a corresponding end of the second outlet hole 22 is provided with a second cut-away portion 221. When the water passage groove 31 is not in communication with the first outlet hole 21 and the movable disc 3 is also being rotated to an angle where the water passage groove 31 does not in communication with the second outlet hole 22 as well, a gap “a” exists between the first cut-away portion 312 and the second cut-away portion 221 to discontinue communication between the water passage groove 31 and the second outlet hole 22 (see FIG. 8). By designing the first cut-away portion 312 and the second cut-away portion 221, the water passage groove 31 and the second outlet hole 22 are not in communication with each other at a certain position and angle. As a result, another side of said end portion of the water passage groove 31 as well as an opposite end portion of the water passage groove 31 can be made wider, also, a length of the second outlet hole 22 can be made longer, accordingly, the maximum amount of water outlet flow of the valve core can be further increased (in terms of shape, an increased amount of water outlet flow implies a greater curvature of the arc-shaped sides 311).

The first outlet hole 21 is configured to communicate with a mechanical water outlet end of a sensor faucet, meaning that the first outlet hole 21 directly communicates with an outlet pipe that no longer requires on-off control; the second outlet hole 22 is configured to communicate with a sensor water outlet end of the sensor faucet, meaning that the second outlet hole is configured to communicate with a solenoid valve; the first inlet hole 23 is configured to communicate with a hot water inlet end; the second inlet hole 24 is configured to communicate with a cold water inlet end. When the valve core is in the state where both the first outlet hole 21 and the second outlet hole 22 is closed (i.e. not being in communication with the water passage groove 31), the sensor water output function is turned off, and the water passage groove 31 communicates with a cold water pipe (see FIG. 8), ensuring that when the sensor water output function is turned on again, cold water instead of hot water will first flow out from the sensor faucet. This prevents the risk of users uninformed of the state of use of the faucet being accidentally scalded. After that, the water can be adjusted to warm or hot water as desired.

The present invention further comprises a dial 5 and a mounting sleeve 6 installed inside the housing 1. The dial 5 is coaxially connected to the movable disc 3 at a side of the movable disc 3 that faces away from the stationary disc 2; the mounting sleeve 6 is rotatably inserted into the housing 1; sliding grooves 61 and flanges 51 are provided on opposing surfaces of the mounting sleeve 6 and the dial 5 respectively; the flanges 51 are slidably fitted within the sliding grooves 61; a through hole 62 is provided penetrating two ends of the mounting sleeve 6; the valve stem 4 passes through the through hole 62; a middle section of the valve stem 4 is rotatably fitted to sidewalls of the through hole 62 via a rotating shaft 7, and an end of the valve stem 4 is embedded into the dial 5. When toggling the valve stem 4, the valve stem 4 can slide the dial 5 relative to the mounting sleeve 6, thereby driving the movable disc 3 to slide such that the water passage groove 31 on the movable disc 3 is capable of being in communication with the first outlet hole 21 and the second outlet hole 22 at different slide positions of the movable disc 3 respectively. When rotating the valve stem 4, the valve stem 4 can drive the mounting sleeve 6 and the dial 5 to rotate synchronously, thereby driving the movable disc 3 to rotate relative to the stationary disc 2 to change an orientation of the water passage groove 31. In this embodiment, a cross-section of the through hole 62 has a rectangular shape; the sliding grooves 61 are provided radially on the mounting sleeve 6.

Furthermore, a surface of the dial 5 which the end of the valve stem 4 is embedded is provided with a slot 52 so that the end of the valve stem 4 is inserted into; when the valve stem 4 toggles due to external force, the valve stem 4 can drive the dial 5 at the slot 52 so that the dial 5 can slide.

Furthermore, the housing 1 comprises an upper housing 11 and a lower cover 12 connected to each other along a vertical direction; the mounting sleeve 6, the dial 5, the movable disc 3, and the stationary disc 2 are sequentially installed into the upper housing 11 and being axially limited by the lower cover 12 to complete the assembly; the upper housing 11 is provided with a axial hole 111 for the mounting sleeve 6 to pass through.

Moreover, two sides of the lower cover 12 are provided with a first sealing gasket 8 and a second sealing gasket 9 respectively. The first sealing gasket 8 is configured to achieve sealing between the lower cover 12 and the stationary disc 2, thus achieving isolation between the first outlet hole 21, the second outlet hole 22, the first inlet hole 23, and the second inlet hole 24; the second sealing gasket 9 is configured to achieve sealing between the lower cover 12 and other components connected to the valve core.

In some embodiments of the lower cover 12 and stationary disc 2, to facilitate easier connections of the stationary disc 2, whose inlet and outlet holes are of non-uniform shapes and sizes, with the inlet and outlet pipes of the valve core, and to improve the overall installation adaptability of the valve core, the present invention also optimizes the structures of the lower cover 12 and the stationary disc 2 as follows:

Firstly, the lower cover 12 is provided with four water passage holes, namely a first water passage hole 121, a second water passage hole 122, a third water passage hole 123, and a fourth water passage hole 124; openings of the first water passage hole 121, the second water passage hole 122, the third water passage hole 123, and the fourth water passage hole 124 on an upper surface of the lower cover 12 are different from openings of the first water passage hole 121, the second water passage hole 122, the third water passage hole 123, and the fourth water passage hole 124 on a lower surface of the lower cover 12; the openings of the first water passage hole 121, the second water passage hole 122, the third water passage hole 123, and the fourth water passage hole 124 on the lower surface of the lower cover 12 facing away from the stationary disc 2 are of a same shape and size and are disposed evenly around an axis of the lower cover 12, thereby facilitating connections with uniformly sized water pipe joints and thus providing a more regular water path arrangement; openings of the first outlet hole 21, the second outlet hole 22, the first inlet hole 23, and the second inlet hole 24 on an upper surface of the stationary disc 2 are different from openings of the first outlet hole 21, the second outlet hole 22, the first inlet hole 23, and the second inlet hole 24 on a lower surface of the stationary disc 2; the openings of the first water passage hole 121, the second water passage hole 122, the third water passage hole 123, and the fourth water passage hole 124 on the upper surface of the lower cover 12 facing towards the stationary disc 2 correspond to the openings of the first outlet hole 21, the second outlet hole 22, the first inlet hole 23, and the second inlet hole 24 on the lower surface of the stationary disc 2 in terms of shape and size, thereby enabling maximum amount of water flow between the lower cover 12 and the stationary disc 2.

Secondly, the openings of the first inlet hole 23 and the second inlet hole 24 on the lower surface of the stationary disc 2 facing towards the lower cover 12 are in a same shape and size and are symmetrically provided as semicircular holes respectively, thereby enabling inlet ends of the first inlet hole 23 and the second inlet hole 24 to be larger, and hence increasing the water inlet flow. Also, a first guiding slope 231 is provided between the inlet end and an outlet end of the first inlet hole 23, and a second guiding slope 241 is provided between the inlet end and an outlet end of the second inlet hole 24; the first guiding slope 231 and the second guiding slope 241 can guide water entering the first inlet hole 23 and the second inlet hole 24 towards their respective outlet ends, thereby reducing obstruction to the water flow and reducing the impact of water pressure on the stationary disc 2 and reducing the loss of water pressure.

Thirdly, the openings of the first outlet hole 21 and the second outlet hole 22 on the lower surface of the stationary disc 2 facing towards the lower cover 12 are of a same shape and size and are symmetrically provided as arc-shaped holes. This enables outlet ends of the first outlet hole 21 and the second outlet hole 22 to be larger, thus catering the increased amount of outputted water resulted from increased water inlet flow obtained in the other solutions of the present invention. Additionally, this design, in conjunction with the solution described in the above paragraph, allows eased directional limitations during assembly between the lower cover 12 and the stationary disc 2, that is to say, even if the lower cover 12 and the stationary disc 2 are rotated 180° relative to each other, assembly can still be completed, thus reducing the likelihood of incorrect assembly.

Fourthly, opposing surfaces of the lower cover 12 and stationary disc 2 are provided with a first embedding groove 125 and a second embedding groove 25 respectively to correspond to the first sealing gasket 8. Two sides of the first sealing gasket 8 are embedded in the first embedding groove 125 and the second embedding groove 25 respectively, and the first sealing gasket 8 is deformed by compressive force of the lower cover 12 and the stationary disc 2, thereby achieving a sealed fit between the lower cover 12 and the stationary disc 2. This ensures that the first outlet hole 21, the second outlet hole 22, the first inlet hole 23, and the second inlet hole 24 are isolated from one another and do not communicate with one another, thereby improving the sealing performance between the lower cover 12 and the stationary disc 2. Particularly, this design can ensure the valve core to be safer and more reliable even with advantage of increased water flow in the valve core according to some aspects of the present invention.

Fifthly, a periphery of the lower cover 12 is provided with a plurality of buckles 126; a periphery of the stationary disc 2 is provided with a plurality of recesses 26 that correspond to the buckles 126; a periphery of the upper housing 11 is provided with buckle holes 112 that correspond to the buckles 126; the buckles 126 are removably fitted into the recesses 26 and buckle to the buckle holes 112, thereby achieving the assembly of the lower cover 12 and the upper housing 11 and axially limiting the stationary disc 2, the movable disc 3, and other components within the upper housing 11.

With reference to FIGS. 6 to 11, the working principle of the present invention is described as follows:

In FIGS. 6 to 11, solid lines represent the stationary disc 2, and broken lines represent the movable disc 3. Directions or orientations mentioned below are described according to the directions or orientations as shown by the figures, and shall not be considered limiting the present invention.

With reference to FIG. 6, when the valve stem 4 does not toggle but rotate to a state where a lower end of the water passage groove 31 points to a bottom-right direction, an upper end of the water passage groove 31 is completely in communication with the first inlet hole 23, the arc-shaped sides 311 avoid the second inlet hole 24, and the lower end of the water passage groove 31 is completely in communication with the second outlet hole 22. Therefore, it is a state of full hot water output from the second water outlet hole 22.

With reference to FIG. 7, when the valve stem 4 does not toggle but rotate to a state where the water passage groove 31 is oriented vertically, the upper end of the water passage groove 31 is partially in communication with the first inlet hole 23 and partially in communication with the second inlet hole 24, and the lower end of the water passage groove 31 is nearly completely in communication with the second outlet hole 22. Therefore, it is a state of mixed hot and cold water output from the second outlet hole 22.

With reference to FIG. 8, when the valve stem 4 does not toggle but rotate to a state where the lower end of the water passage groove 31 points to a bottom-left direction, the upper end of the water passage groove 31 is completely in communication with the second inlet hole 24, the arc-shaped sides 311 avoid the first inlet hole 23, and the lower end of the water passage groove 31 is also completely not in communication with the second outlet hole 22. Therefore, it is the state of the second outlet hole 22 being closed.

In the above three states, since the first outlet hole 21 will not be in any extent communicate with the water passage groove 31, the first water outlet hole 21 is in a non-water output state. In other words, the first outlet hole 21 will only open for water output after the valve stem 4 is toggled. In the above three states, by rotating the valve stem 4, a temperature of the water output from the second outlet hole 22 can be adjusted, or the second outlet hole 22 can be closed. After toggling the valve stem 4, due to the specifically designed length of the water passage groove 31, the water passage groove 31 will not be in any extent communicate with the second outlet hole 22, and the second outlet hole 22 stops water output.

With reference to FIG. 9, when the valve stem 4 is toggled and rotated to a state where the upper end of the water passage groove 31 points to an upper-left direction, the upper portion of the water passage groove 31 is simultaneously in communication with the first outlet hole 21 and the first inlet hole 23, and the arc-shaped sides 311 avoid the second inlet hole 24. Therefore, it is a state of full hot water output from the first outlet hole 21.

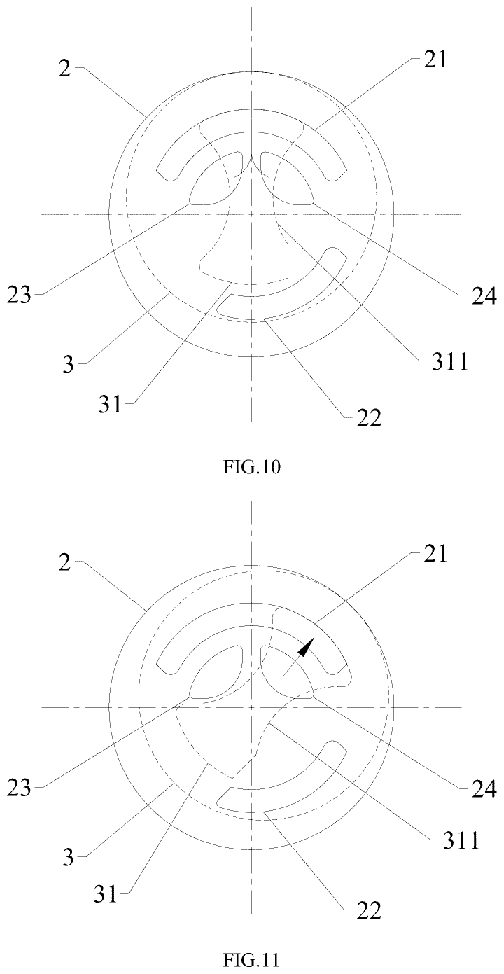

With reference to FIG. 10, when the valve stem 4 is toggled and rotated to a state where the water passage groove 31 is oriented vertically, the upper portion of the water passage groove 31 is simultaneously in communication with the first outlet hole 21, the first inlet hole 23, and the second inlet hole 24. Therefore, it is the state of mixed hot and cold water output from the first outlet hole 21.

With reference to FIG. 11, when the valve stem 4 is toggled and rotated to a state where the upper end of the water passage groove 31 points to an upper-right direction, the upper portion of the water passage groove 31 is simultaneously in communication with the first outlet hole 21 and the second inlet hole 24, and the arc-shaped sides 311 avoid the first inlet hole 23. Therefore, it is the state of full cold water output from the first outlet hole 21.

In the above three states, by adjusting an extent which the valve stem 4 toggles, an area of communication between the water passage groove 31 and the first outlet hole 21 can be adjusted radially, thereby adjusting the amount of water flowing out of the first outlet hole 21.

The present invention further discloses a sensor faucet 10 as shown in FIG. 17, installed with the aforementioned valve core. Therefore, the sensor faucet also possesses the technical effects of the valve core. Details of the sensor faucet will not be described herein.

What is claimed is:

1. A valve core, comprising:
a housing, a stationary disc, a movable disc, and a valve stem;
the stationary disc and the movable disc are both installed inside the housing;
the stationary disc is provided with a first outlet hole, a second outlet hole, a first inlet hole, and a second inlet hole; the first outlet hole and the second outlet hole are arc-shaped holes penetrating upper and lower portions of opposite sides of the stationary disc respectively; the first inlet hole and the second inlet hole penetrates left and right portions of the opposite sides the stationary disc, and the first inlet hole and the second inlet hole are disposed within an area of circular enclosure defined by the first outlet hole and the second outlet hole;
the movable disc is movably and sealingly engaged with the stationary disc, and a surface of the movable disc adjacent to the stationary disc when the movable disc is engaged with the stationary disc is provided with a water passage groove;
the valve stem is inserted into the housing and is connected to the movable disc to transmit motion so as to drive the movable disc to rotate and/or slide on the stationary disc;
a length of the water passage groove ensures that when the movable disc moves on the stationary disc, the water passage groove is not in communication with any of the first outlet hole or the second outlet hole, or is in communication with either the first outlet hole or the second outlet hole at a respective end thereof; a length of the second outlet hole ensures that when the water passage groove is not in communication with the first outlet hole, the movable disc is capable to be rotated to an angle where the water passage groove is also not in communication with the second outlet hole.

2. The valve core of claim 1, wherein a center of the circular enclosure defined by the first outlet hole and the second outlet hole coincides with a center of the stationary disc; and arc radii of both the first outlet hole and the second outlet hole are equal; a lengthwise direction of the water passage groove is oriented radially on the movable disc.

3. The valve core of claim 1, wherein a right end portion of an opening of the first outlet hole facing towards the movable disc and a right end portion of an opening of the second outlet hole facing towards the movable disc are shaped as up-side down mirror images; a left end portion of an opening of the second outlet hole facing towards the movable disc is shorter than a left end portion of an opening of the first outlet hole facing towards the movable disc.

4. The valve core of claim 1, wherein two sides of the water passage groove along a lengthwise direction thereof are shaped as arc-shaped sides; a space between the two arc-shaped sides gradually increases from a middle section to two end portions respectively.

5. The valve core of claim 4, wherein one side of an end portion of the water passage groove capable of being in communication with the second outlet hole is provided with a first cut-away portion that is capable of avoiding said end portion of the water passage groove from communicating with the second outlet hole; a corresponding end of the second outlet hole is provided with a second cut-away portion; when the water passage groove is not in communication with the first outlet hole and the movable disc is also being rotated to an angle where the water passage groove does not in communication with the second outlet hole as well, a gap exists between the first cut-away portion and the second cut-away portion to discontinue communication between the water passage groove and the second outlet hole.

6. The valve core of claim 1, wherein the valve core further comprises a dial and a mounting sleeve installed inside the housing; the dial is coaxially connected to the movable disc at a side of the movable disc that faces away from the stationary disc; the mounting sleeve is rotatably inserted into the housing;
sliding grooves and flanges are provided on opposing surfaces of the mounting sleeve and the dial respectively; the flanges are slidably fitted within the sliding grooves; a through hole is provided penetrating two ends of the mounting sleeve; the valve stem passes through the through hole; a middle section of the valve stem is rotatably fitted to sidewalls of the through hole via a rotating shaft, and an end of the valve stem is embedded into the dial; when toggling the valve stem, the valve stem slides the dial relative to the mounting sleeve; when rotating the valve stem, the valve stem drives the mounting sleeve and the dial to rotate synchronously.

7. The valve core of claim 6, wherein a cross-section of the through hole has a rectangular shape; the sliding grooves are provided radially on the mounting sleeve.

8. The valve core of claim 6, wherein a surface of the dial which the end of the valve stem is embedded is provided with a slot so that the end of the valve stem is inserted into.

9. The valve core of claim 1, wherein the housing comprises an upper housing and a lower cover connected to each other along a vertical direction; the movable disc and the stationary disc are sequentially installed into the upper housing and being axially limited by the lower cover; the valve stem is inserted into the upper housing; a first sealing gasket is provided between the lower cover and the stationary disc.

10. The valve core of claim 9, wherein the lower cover is provided with a first water passage hole, a second water passage hole, a third water passage hole, and a fourth water passage hole; openings of the first water passage hole, the second water passage hole, the third water passage hole, and the fourth water passage hole on an upper surface of the lower cover are different from openings of the first water passage hole, the second water passage hole, the third water passage hole, and the fourth water passage hole on a lower surface of the lower cover; the openings of the first water passage hole, the second water passage hole, the third water passage hole, and the fourth water passage hole on the lower surface of the lower cover facing away from the stationary disc are of a same shape and size and are disposed evenly around an axis of the lower cover; openings of the first outlet hole, the second outlet hole, the first inlet hole, and the second inlet hole on an upper surface of the stationary disc are different from openings of the first outlet hole, the second outlet hole, the first inlet hole, and the second inlet hole on a lower surface of the stationary disc; the openings of the first water passage hole, the second water passage hole, the third water passage hole, and the fourth water passage hole on the upper surface of the lower cover facing towards the stationary disc correspond to the openings of the first outlet hole, the second outlet hole, the first inlet hole, and the second inlet hole on the lower surface of the stationary disc in terms of shape and size.

11. The valve core of claim 10, wherein the openings of the first inlet hole and the second inlet hole on the lower surface of the stationary disc facing towards the lower cover are in a same shape and size and are symmetrically provided as semicircular holes respectively; a first guiding slope is provided between an inlet end and an outlet end of the first inlet hole, and a second guiding slope is provided between an inlet end and an outlet end of the second inlet hole.

12. The valve core of claim 11, wherein the openings of the first outlet hole and the second outlet hole on the lower surface of the stationary disc facing towards the lower cover are of a same shape and size and are symmetrically provided as arc-shaped holes.

13. The valve core of claim 9, wherein opposing surfaces of the lower cover and stationary disc are provided with a first embedding groove and a second embedding groove respectively to correspond to the first sealing gasket; two sides of the first sealing gasket are embedded in the first embedding groove and the second embedding groove respectively, and the first sealing gasket is deformed by compressive force of the lower cover and the stationary disc.

14. The valve core of claim 9, wherein a periphery of the lower cover is provided with a plurality of buckles; a periphery of the stationary disc is provided with a plurality of recesses that correspond to the buckles; a periphery of the upper housing is provided with buckle holes that correspond to the buckles; the buckles are removably fitted into the recesses and buckle to the buckle holes.

15. A sensor faucet, installed with the valve core of claim 1.
